(19) United States
(12) Patent Application Publication
(10) Pub. No.: US 2016/0070648 A1
(43) Pub. Date: Mar. 10, 2016

(54) DATA STORAGE SYSTEM AND OPERATION METHOD THEREOF

(71) Applicant: Lite-On Technology Corporation, Taipei City (TW)

(72) Inventor: Ming-Huang Wu, Taipei City (TW)

(21) Appl. No.: 14/594,163

(22) Filed: Jan. 11, 2015

(30) Foreign Application Priority Data
Sep. 4, 2014 (CN) 201410447173.8

(51) Int. Cl. G06F 12/08

(52) U.S. Cl. CPC G06F 12/0866; G06F 2212/2146

(57) ABSTRACT

A data storage system and an operation method thereof are provided. The data storage system includes a data storage module, a cache module and a data accessing module. The data accessing module is coupled to the data storage module and the cache module. When the data accessing module receives a data-write command from a host, the data accessing module is configured to reply a writing-completed command to the host after storing writing-data of the data-write command into the cache module, arrange the data-write command into a data-writing schedule table, and write the writing-data read from the cache module into the data storage module according to the data-writing schedule table.

### CROSS-REFERENCE TO RELATED APPLICATION

This application claims the priority benefit of China application serial no. 201410447173.8, filed on Sep. 4, 2014. The entirety of the above-mentioned patent application is hereby incorporated by reference herein and made a part of this specification.

### BACKGROUND OF THE INVENTION

1. Field of the Invention

The invention relates to a data storage system and an operation method thereof, and more particularly, relates to a data storage system and an operation method thereof which are capable of processing a data-write command in divided processes.

2. Description of Related Art

At present, mass storage devices in the market can be mainly divided into a traditional hard drive disk (HDD) composed of a magnetic head and a magnetic disk, and a solid state disk (SSD) composed of a non-volatile memory. Generally speaking, when a data-write command sent by a host is received, the storage device can reply a writing-completed command to the host only after confirming that data have been completely written into a major storage module (the disk or the non-volatile memory). Also, the host can send the next command to the storage device only after the writing-completed command is received. However, an overall performance of a computer system may be affected by a relatively longer time spent for writing the data completely into the major storage module (the disk or the non-volatile memory). Therefore, it is an important issue when designing the storage device as how to improve both access speed between the storage device and the host and reliability of the storage device in terms of data storage.

### SUMMARY OF THE INVENTION

The invention is directed to a data storage system and an operation method thereof, which are capable of processing a data-write command in divided processes through a data accessing module to improve a data read/write performance of the data storage system while significantly reducing an amount of data loss for the data storage system, so as to improve a reliability of the data storage system in terms of data storage.

The data storage system of the invention includes a data storage module, a cache module and a data accessing module. The data accessing module is coupled to the data storage module and the cache module. When the data accessing module receives a data-write command from a host, the data accessing module is configured to reply a writing-completed command to the host after storing writing-data of the data-write command into the cache module, arrange the data-write command into a data-writing schedule table, and write the writing-data read from the cache module into the data storage module according to the data-writing schedule table.

In an embodiment of the invention, the data accessing module has a cache data correspondence table and the data-writing schedule table. The cache data correspondence table is configured to record corresponding address information of the writing-data stored in the cache module, and the data-writing schedule table is configured to arrange a writing schedule for the data-write command.

In an embodiment of the invention, the data accessing module updates the cache data correspondence table according to a logical address corresponding to the writing-data and a physical address of the writing-data stored in the cache module.

In an embodiment of the invention, the data accessing module searches the cache data correspondence table according to the logical address corresponding to the writing-data in order to obtain the physical address of the writing-data stored in the cache module.

In an embodiment of the invention, when the data accessing module receives a data-read command from the host, the data accessing module confirms whether reading-data that the data-read command intends to read is stored in the cache module through the cache data correspondence table. When the reading-data is stored in the cache module, the data accessing module reads the reading-data from the cache module. When the reading-data is not stored in the cache module, the data accessing module reads the reading-data from the data storage module.

In an embodiment of the invention, while the data accessing module replies the writing-completed command, the writing-data of the data-write command corresponding to the writing-completed command is not yet written into the data storage module.

An operation method of a data storage system includes the following steps. A data-write command from a host is received. A writing-completed command is replied to the host after storing writing-data of the data-write command into a cache module. The data-write command is arranged into a data-writing schedule table. The writing-data is read from the cache module and written into a data storage module according to the data-writing schedule table.

In an embodiment of the invention, the operation method of the data storage system further includes: after storing writing-data of the data-write command into a cache module, recording a logical address of the writing-data and a physical address of the writing-data stored in the cache module into a cache data correspondence table.

In an embodiment of the invention, the operation method of the data storage system further includes: searching the cache data correspondence table according to the logical address corresponding to the writing-data in order to obtain the physical address of the writing-data stored in the cache module.

In an embodiment of the invention, the operation method of the data storage system further includes: receiving a data-read command from a host; confirming whether reading-data that the data-read command intends to read is stored in the cache module through the cache data correspondence table; when the reading-data is stored in the cache module, the data accessing module reads the reading-data from the cache module; and when the reading-data is not stored in the cache module, the data accessing module reads the reading-data from the data storage module.

Based on the above, in the data storage system and the operation method thereof according to the embodiments of the invention, the data accessing module replies the writing-completed command to the host right after storing the writing-data into the cache module. Therefore, the processing speed of the host may be effectively increased to thereby improve the data read/write performance of the data storage system. Furthermore, the data storage system is capable of gradually writing the writing-data from the cache module into the data storage module in the background processing. Accordingly, the amount of data loss can be significantly reduced for the data storage system, so as to improve the reliability of the data storage system in terms of data storage.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic system diagram of a data storage system according to an embodiment of the invention.

FIG. 2 is a flowchart illustrating an operation method of a data storage system according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

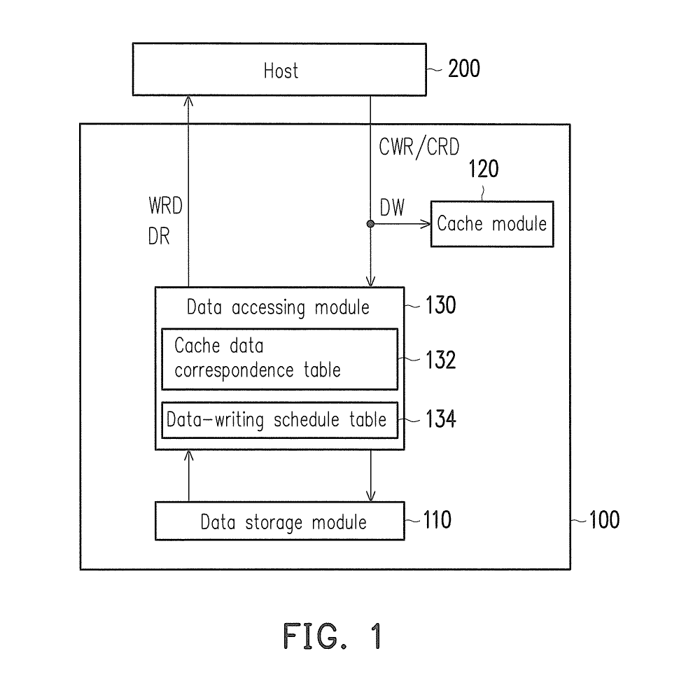

FIG. 1 is a schematic system diagram of a data storage system according to an embodiment of the invention. Referring to FIG. 1, in the present embodiment, a data storage system 100 includes a data storage module 110, a cache module 120 and a data accessing module 130. The data storage module 110 is a major storage module of the data storage system 100 configured to store user data. Also, the data stored in the data storage module 110 does not disappear when power outage occurs on the data storage system 100. The data storage module 110 includes, for example, a hard disk device or a solid state device, but the embodiments of the invention are not limited thereto. The data storage module 110 may also be a storage device adopting other data storage technologies. The cache module 120 is configured to temporarily store the user data.

An access speed for the data of the cache module 120 is higher than that of the data storage module 110, and the data stored in the cache module 120 disappears when power outage occurs on the data storage system 100.

In the present embodiment, the data accessing module 130 is coupled to the data storage module 110 and the cache module 120, and the data accessing module 130 includes a cache data correspondence table 132 and a data-writing schedule table 134. The cache data correspondence table 132 is configured to record corresponding address information of writing-data stored in the cache module 120, and the data-writing schedule table 134 is configured to arrange a writing schedule for a received data-write command. The data accessing module 130 is configured to execute corresponding system operations according to a data-read command or the data-write command being received. The system operations include (but not limited to): replying the received data-write command, establishing/updating the cache data correspondence table, establishing/updating the data-writing schedule table, and ensuring a data correctness of the writing-data. The operation method of the data storage system 100 while receiving the data-read command and the data-write command are respectively described in detail as follows.

Referring to FIG. 1, when the data storage system 100 receives a data-write command CWR sent from a host 200, the data storage system 100 stores writing-data DW of the data-write command CWR into the cache module 120. Meanwhile, when the data accessing module 130 receives the data-write command CWR, the data accessing module 130 directly replies a writing-completed command WRD to the host 200, and updates the data-write command CWR at the time into the data-writing schedule table 134. When the writing-completed command WRD is received by the host 200, the host 200 may then send the next command to the data storage system 100. If the next command sent by the host 200 is still the data-write command CWR, the data storage system 100 may first store the writing-data DW into the cache module 120 according to aforesaid operation flows. Meanwhile, the data accessing module 130 directly replies the writing-completed command WRD to the host 200, and updates the data-write command CWR at the time into the data-writing schedule table 134.

By using aforesaid operation flows, the host 200 does not have to practically wait for a writing time spent by the data storage system 100 for storing the writing-data DW into the data storage module 110. Therefore, a processing speed of the host 200 may be effectively increased to thereby improve a data read/write performance of the data storage system 100.

Furthermore, in the data-write command CWR sent by the host 200, a logical address corresponding to the writing-data DW is also included in addition to the writing-data DW. In the present embodiment, after the data storage system 100 stores the writing-data DW of the data-write command CWR into the cache module 120, the data accessing module 130 establishes/updates the cache data correspondence table 132 according to the logical address corresponding to the writing-data DW and the physical address of the writing-data DW stored in the cache module 120. In other words, the cache data correspondence table 132 is configured to record the logical address corresponding to the writing-data DW of each of the data-write commands CWR and the physical address of the writing-data DW stored in the cache module 120.

Based on the above, after the data accessing module 130 receives the data-write commands CWR and directly replies the writing-completed commands WRD to host 200, the data accessing module 130 may sequentially arrange the received data-write commands CWR into the data-writing schedule table 134, and sequentially execute the data-write commands CWR according to the order listed in the data-writing schedule table 134 to read the corresponding writing-data DW from the cache module 120 and write into the data storage module 110. In an embodiment of the invention, for the writing-data DW corresponding to each of the data-write commands CWR, the corresponding logical addresses may be utilized to search the cache data correspondence table 132 in order to find out the physical addresses of the corresponding writing-data DW stored in the cache module 120. Next, through the physical addresses, the data accessing module 130 may read the corresponding writing-data DW from the cache module 120 and write the writing-data DW into the data storage module 110.

In the embodiments of the invention, the data storage system 100 divides a data-writing process corresponding to the data-write command CWR executed by the data accessing module 130 into a foreground processing and a background processing. In the foreground processing, after the data-write command CWR is received, the data storage system 100 first stores the writing data DW into the cache module 120, and then directly replies the writing-completed command WRD to the host 200 before writing the writing-data DW into the data storage module 110, so as to maintain the processing speed between the data storage system 100 and the host 200 and the data read/write performance. Meanwhile, in the foreground processing, the data accessing module 130 establishes the data-writing schedule table 134 according to a receive sequence of the received data-write commands CWR, and records corresponding related address information into the cache data correspondence table 132, so as to facilitate in executing the subsequent background processing.

Based on the above, although the data storage system 100 has already replied the writing-completed command WRD directly to the host 200 in the foreground processing, practically, the writing-data DW is not yet written into the data storage module 110. In the embodiments of the invention, the writing data DW is written into the data storage module 110 in the background processing. In the background processing, the data storage system 100 gradually processes the previously received data-write commands CWR according to the data-writing schedule table 134, reads the corresponding writing-data DW from the cache module 120 according to the cache data correspondence table 132, and writes the writing-data DW into the data storage module 110. Because the data storage system 100 continues to write the writing-data DW from the cache module 120 into the data storage module 110 in the background processing, when the writing-data DW in the cache module 120 disappears in case of power outage, the writing-data DW in the cache module 120 have already been written into the data storage module 110. Therefore, an amount of data loss can be significantly reduced to improve a reliability of the data storage system 100 in terms of data storage.

In the embodiments of the invention, the foreground processing and the background processing may be executed simultaneously or alternately. Moreover, a timing for staring the background processing may be decided in consideration of operating states (e.g., a busy state or an idle state) of the data storage system 100, so that the background processing in which the writing-data DW are practically written into the data storage module 110 may be executed without affecting an operating performance of the data storage system 100.

In another embodiment of the invention, the data accessing module 130 may execute a data correctness check before writing the writing-data DW into the data storage module 110. In the background processing, the data storage system 100 may gradually process the previously received data-write commands CWR according to the data-writing schedule table 134. Because the received data-write commands CWR are all sequentially arranged into the data-writing schedule table 134, it is also possible that a command content of the data-write command CWR being received relatively later may include the writing-data of the data-write command CWR being received relatively earlier. In other words, the data-write command CWR being received relatively later may contain an update writing-data for updating an old writing-data contained in the data-write command CWR being received relatively earlier and not being written into the data storage module 110 yet. Therefore, before writing the writing-data DW into the data storage module 110, the data accessing module 130 may first confirm whether the subsequent data-write command CWR intends to update the writing-data DW of the earlier data-write command CWR in the data-writing schedule table 134. That is, whether the subsequent data-write command CWR intends to update the current writing-data DW is confirmed, such that whether to directly read the updated writing-data DW and directly write the updated writing-data DW into the data storage module 110 may then be decided. Accordingly, other than ensuring the data correctness, a time spent for repeatedly writing the writing-data DW and the update writing-data DW corresponding to the same logical address may also be saved.

For instance, it is assumed that the data storage system 100 receives a first data-write command CWR1 and a second data-write command CWR2 in that sequence. Among them, a command content of the first data-write command CWR1 includes writing a first writing-data DW1 into the data storage module 110, and a command content of the second data-write command CWR2 includes updating the first writing-data DW1 into a second writing-data DW2. In the foreground processing, the data accessing module 130 respectively stores the first writing-data DW 1 and the second writing data DW2 into the cache module 120, and records the corresponding related address information into the cache data correspondence table 132. As mentioned above, the corresponding related address includes relationship of the logical address of the first writing-data DW1 and the physical address that the first writing-data DW1 stored in the cache module 120. Also the relationship of the logical address of the second writing data DW2 and the physical address that the second writing data DW2 stored in the cache module 120. Subsequently, the data accessing module 130 directly replies the writing-completed commands WRD to the host 200, and respectively arranges the first data-write command CWR1 and the second data-write command CWR2 into the data-writing schedule table 134.

In the background processing, the data accessing module 130 may gradually process the received data-write commands CWR according to the data-writing schedule table 134. While processing the first data-write command CWR1, the data accessing module 130 confirms whether the subsequent data-write command CWR in the data-writing schedule table 134 intends to update the first writing-data DW1. That is, whether the data-write command CWR corresponding to the same logical address exists is confirmed. Once the data accessing module 130 found that the command content of the second data-write command CWR2 includes updating the first writing-data DW1 into the second writing-data DW2, the data accessing module 130 can ignore the first data-write command CWR1 and directly execute the second data-write command CWR2 instead. In this case, according to the cache data correspondence table 132, the data accessing module 130 may write the updated second writing-data DW2 read from the cache module 120 into the data storage module 110. That is, the first data-write command CWR1 is replaced by the second data-write command CWR2, and an original data schedule for the second data-write command CWR2 is removed. Accordingly, updated data (the second writing-data DW2) may be correctly written into the data storage module 110, and a time spent for writing the original writing-data DW (the first writing-data DW1) may be saved, so as to improve the data read/write performance and the data correctness of the data storage system 100.

In the embodiments of the invention, when the data storage system 100 receives a data-read command CRD sent from the host 200, the data accessing module 130 searches the cache data correspondence table 132 according to a logical address of reading-data DR that the data-read command CRD intends to read, so as to confirm whether the reading-data DR required by data-read command CRD is stored in the cache module 120. When the reading-data DR required by the data-read command CRD is stored in the cache module 120, the data accessing module 130 can locate a physical address of the reading-data DR stored in the cache module 120 from the cache data correspondence table 132 according to the logical address of the reading-data DR that the data-read command CRD intends to read, so as to read the reading-data DR required by the data-read command CRD from the cache module 120, and directly reply with the required reading-data DR required by the data-read command CRD. When the reading-data DR required by the data-read command CRD is not stored in the cache module 120, the data accessing module 130 accesses the data storage module 110 instead, so as to read the reading-data DR required by the data-read command CRD from the data storage module 110, and then reply with the reading-data DR required by the data-read command CRD.

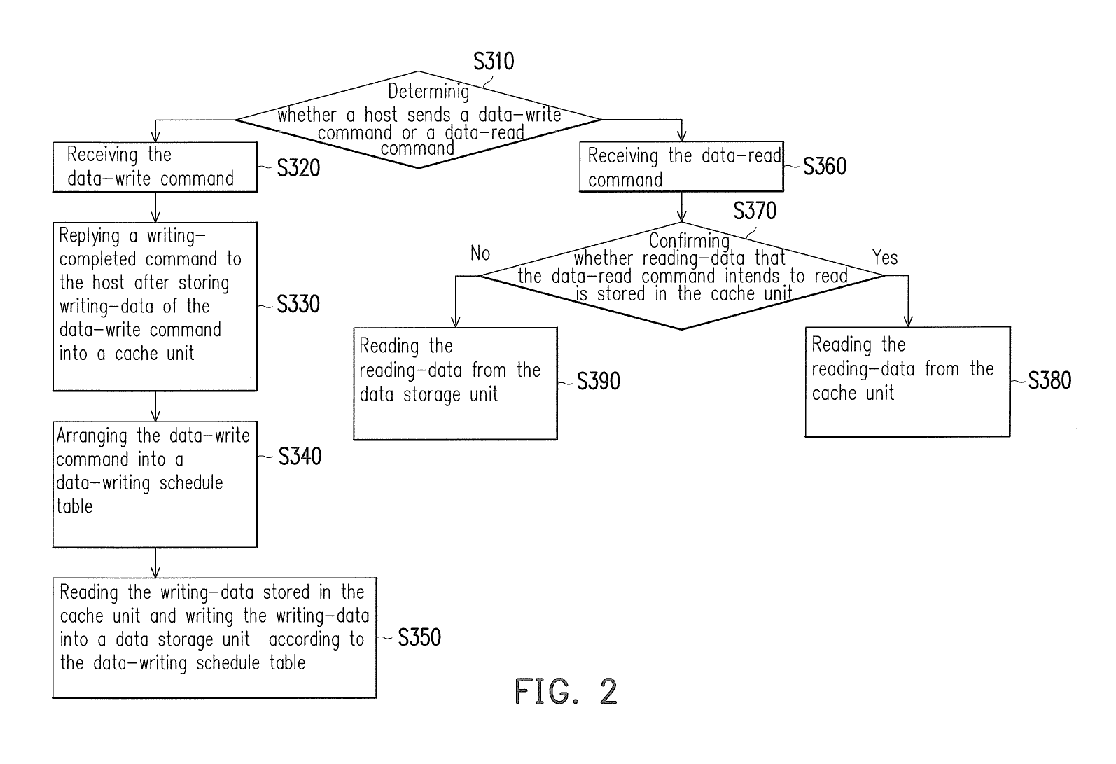

FIG. 2 is a flowchart illustrating an operation method of a data storage system according to an embodiment of the invention. Referring to FIG. 2, in the present embodiment, the operation method of the data storage system includes the following steps. First of all, whether a host sends a data-write command or a data-read command is determined (step S310). If the host sends the data-write command, the data storage system receives the data-write command (step S320). Subsequently, the data accessing module replies a writing-completed command to the host after storing writing-data of the data-write command into a cache module (step S330). Subsequently, the data accessing module arranges the data-write command into a data-writing schedule table (step S340). Next, the data accessing module reads the writing-data stored in the cache module and writes the writing-data into the data storage module according to the data-writing schedule table (step S350).

On the other hand, if the host sends the data-read command, the data storage system receives the data-read command (step S360). Subsequently, the data accessing module confirms whether reading-data that the data-read command intends to read is stored in the cache module (step S370). When the reading-data that the data-read command intends to read is stored in the cache module (i.e., a determination result of step S370 is “Yes”), the data accessing module reads the reading-data from the cache module (step S380). Otherwise, when the reading-data that the data-read command intends to read is not stored in the cache module (i.e., the determination result of step S370 is “No”), the data accessing module reads the reading-data from the data storage module (step S390). A sequence of steps S310, S320, S330, S340, S350, S360, S370, S380 and S390 is merely an example, the embodiments of the invention are not limited thereto. Further, details regarding steps S310, S320, S330, S340, S350, S360, S370, S380 and S390 may refer to the embodiment of FIG. 1, and thus related description is not repeated hereinafter.

In summary, in the data storage system and the operation method thereof according to the embodiments of the invention, the data accessing module replies the writing-completed command to the host right after storing the writing-data into the cache module. Therefore, the processing speed of the host may be effectively increased to thereby improve the data read/write performance of the data storage system. Furthermore, the data storage system is capable of gradually writing the writing-data from the cache module into the data storage module in the background processing. Accordingly, the amount of data loss can be significantly reduced for the data storage system, so as to improve the reliability of the data storage system in terms of data storage.

Although the present invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A data storage system, comprising:
a data storage module;
a cache module; and
a data accessing module, coupled to the data storage module and the cache module,
wherein when the data accessing module receives a data-write command from a host, the data accessing module is configured to reply a writing-completed command to the host after storing writing-data of the data-write command into the cache module, arrange the data-write command into a data-writing schedule table, and write the writing-data read from the cache module into the data storage module according to the data-writing schedule table.

2. The data storage system according to claim 1, wherein the data accessing module has a cache data correspondence table and the data-writing schedule table, wherein the cache data correspondence table is configured to record corresponding address information of the writing-data stored in the cache module, and the data-writing schedule table is configured to arrange a writing schedule for the data-write command.

3. The data storage system according to claim 2, wherein the data accessing module updates the cache data correspondence table according to a logical address corresponding to the writing-data and a physical address of the writing-data stored in the cache module.

4. The data storage system according to claim 3, wherein the data accessing module searches the cache data correspondence table according to the logical address corresponding to the writing-data in order to obtain the physical address of the writing-data stored in the cache module.

5. The data storage system according to claim 1, wherein when the data accessing module receives a data-read command from the host, the data accessing module confirms whether reading-data that the data-read command intends to read is stored in the cache module; when the reading-data is stored in the cache module, the data accessing module reads the reading-data from the cache module; and when the reading-data is not stored in the cache module, the data accessing module reads the reading-data from the data storage module.

6. The data storage system according to claim 1, wherein while the data accessing module replies the writing-completed command, the writing-data of the data-write command corresponding to the writing-completed command is not yet written into the data storage module.

7. The data storage system according to claim 1, wherein the data accessing module arranges the received data-write commands into the data-writing schedule table, and execute the received data-write commands according to an order listed in the data-writing schedule table to read the corresponding writing-data from the cache module and write into the data storage module.

8. An operation method of a data storage system, comprising:
receiving a data-write command from a host;
replying a writing-completed command to the host after storing writing-data of the data-write command into a cache module;
arranging the data-write command into a data-writing schedule table; and
writing the writing-data read from the cache module into a data storage module according to the data-writing schedule table.

9. The operation method of the data storage system according to claim 8, wherein after storing the writing-data of the data-write command into the cache module, the operation method further comprises:
recording a logical address of the writing-data and a physical address of the writing-data stored in the cache module into a cache data correspondence table.

10. The operation method of the data storage system according to claim 9, wherein the step of writing the writing-data read from the cache module into the data storage module according to the data-writing schedule table further comprises:
searching the cache data correspondence table according to the logical address corresponding to the writing-data in order to obtain the physical address of the writing-data stored in the cache module.

11. The operation method of the data storage system according to claim 8, wherein while replying the writing-completed command, the writing-data of the data-write command corresponding to the writing-completed command is not yet written into the data storage module.

12. The operation method of the data storage system according to claim 8, wherein the step of writing the writing-data read from the cache module into the data storage module according to the data-writing schedule table further comprises:
executing the received data-write commands according to an order listed in the data-writing schedule table to read the corresponding writing-data from the cache module and write into the data storage module.
